(19) United States
(12) Patent Application Publication
(10) Pub. No.: US 2018/0113374 A1
(43) Pub. Date: Apr. 26, 2018

(54) CAMERA MODULE

(71) Applicant: JIANGXI SENYANG TECHNOLOGY COMPANY LIMITED, Ganzhou, Jiangxi (CN)

(72) Inventors: Zhiyong Du, Ganzhou, Jiangxi (CN); Renzhu Huang, Ganzhou, Jiangxi (CN)

(21) Appl. No.: 15/315,063

(22) PCT Filed: Oct. 24, 2016
(86) PCT No.: PCT/CN2016/103082

§ 371 Date: Nov. 30, 2016

(51) Int. Cl. G03B 13/36; G02B 27/64

(52) U.S. Cl. CPC G03B 13/36; G02B 27/646

(57) ABSTRACT

Disclosed is a camera module, the camera module comprises a bottom base (400), a shell body matched with the bottom base (400), hollowed and is provided with an opening at a top surface thereof, and a lens component (100) and a carrier (300) received in the shell body (200). The camera module further comprises two groups of moving members (600) arranged between an outer wall of the carrier (300) and the shell body (200), the lens component (100) is received in the carrier (300) and moves with respect to the bottom base (400) through the at least two groups of moving members (600). The camera module has prominent advantages including a simple inner structure, being easy to be carried, a quick response of focusing, a stable focusing performance, and an excellent imaging effect.

### TECHNICAL FIELD

The present application relates to a photographing device, and more particularly relates to a camera module having an auto-focusing functionality.

### BACKGROUND

In order to be conveniently carried by a user, most of photographing devices in the market have light weight designs, and an inner space of each of these devices is designed to be more and more compact. However, due to limited inner space, this kind of photographing device is usually provided with a built-in VCM (Voice Coil Motor), and achieves a focusing function through a shrapnel structure, and thus the photographing device exists performance deficiencies of slow focusing speed, poor focusing accuracy, and unstable focusing performance.

### BRIEF DESCRIPTION

A purpose of the present invention is that: the prior art photographing device achieves a focusing function through a shrapnel structure, and thus there exists technical deficiencies of slow focusing speed, poor focusing accuracy, and unstable focusing performance, so that a camera module is provided which has good performances, simple structure, easy to carry, fast focusing speed and high focusing accuracy.

The present invention solves the aforesaid technical problems by taking a technical solution, that is, providing a camera module comprising a bottom base, a hollow shell body provided with an opening at a top surface thereof and matched with the bottom base, and a lens component and a carrier received in the shell body;

the camera module further comprises:

at least two groups of moving members arranged between an outer wall of the carrier and the shell body, the lens component is received in the carrier and can move relative to the bottom base through the at least two groups of moving members.

In the aforesaid camera module of the present invention, each group of moving members comprises at least three balls, the camera module forms a first accommodation area and a second accommodation area between the carrier and the bottom base, the at least three balls are stacked up in a direction vertical to a bottom surface of the bottom base, and a stack height of the at least three balls is lower than a height of the first accommodation area or the second accommodation area relative to the bottom surface of the bottom base.

In the aforesaid camera module of the present invention, an inner wall of the bottom base comprises a carrier matching surface and a lens component displacement reference surface;

the carrier correspondingly comprises a first lens component limiting member formed by extending along the carrier matching surface, a second lens component limiting member oppositely arranged with respect to the lens component displacement reference surface, and two connecting pieces formed between the first lens component limiting member and the second lens component limiting member respectively.

In the aforesaid camera module of the present invention, each of the connecting pieces is recessed in the center axial direction of the carrier and forms the first accommodation area and the second accommodation area together with one side wall of the bottom base at two sides of the second lens component limiting member.

In the aforesaid camera module of the present invention, each of the connecting pieces comprises a first ball limiting part and a second ball limiting part, wherein the first ball limiting part is protruded towards a direction of the carrier matching surface of the bottom base, the second ball limiting part is connected with one side face of the second lens component limiting member, and there is a smooth transition between the second ball limiting part and the side face;

the first accommodation area and the second accommodation area are formed by the first ball limiting part together with the second ball limiting part, the carrier matching surface and the lens component displacement reference surface.

In the aforesaid camera module of the present invention, the carrier forms one profile having an approximate inverse U-shape at one side near the first lens component limiting member, and forms another profile having an approximate Ω-shape at another side near the second lens component limiting member.

In the aforesaid camera module of the present invention, the carrier is an integrally formed metal piece.

In the aforesaid camera module of the present invention, an outer surface of the first lens component limiting member is provided thereon with various cushions of different shapes configured for performing isolation protections for the lens component.

In the aforesaid camera module of the present invention, an outer side of the second lens component limiting member is provided with a first mounting hole, and the lens component displacement reference surface of the bottom base is correspondingly provided with a second mounting hole;

the camera module further comprises:

a magnet piece embedded in the first mounting hole and a driver IC embedded in the second mounting hole; and

a coil arranged between the driver IC and the magnet piece and electrically connected with the driver IC; wherein when the coil is energized, it drives the lens component and makes the lens component to move along the lens component displacement reference surface and with respect to the bottom base, and further drives a lens in the lens component to stretch out or retract from the opening of the shell body.

In the aforesaid camera module of the present invention, peripheries of the top of the shell body is provided thereon with at least three third mounting holes, peripheries of a top of the first lens component limiting member is correspondingly provided with fourth mounting holes which have the same number with the third mounting holes and are matched with the third mounting holes, and the shell body and the carrier are fixed together by at least three fastening pieces that respectively pass through at least three pairs of the third mounting holes and the fourth mounting holes that match with each other.

By implementing the camera module of the present invention, at least advantageous effects in the following can be achieved:

One, the camera module of the present invention has a simple inner structure, the first accommodation area and the second accommodation area are arranged between the carrier and the bottom base and respectively configured for accommodating the at least two groups of ball-type moving members, the second lens component limiting member of the carrier and the lens component displacement reference surface of the bottom base are respectively provided with the first mounting hole configured for receiving the coil and the second mounting hole configured for receiving magnet piece, such that a limited inner space of the camera module can be effectively utilized, and fast focusing function can be implemented.

Two, the carrier comprises the first lens component limiting member that is substantially circular-shaped, the second lens component limiting member that is substantially rectangle-shaped, and two connecting pieces connected between the first lens component limiting member and the second lens component limiting member; the carrier forms an approximate inverse U-shaped profile at one side near the first lens component limiting member, and forms an approximate pulse-shaped profile at another side near the second lens component limiting member, and the carrier is integrally molded by metal material. In one aspect, the carrier having the aforesaid structural design can not only achieve a relative movement between the lens component and the bottom surface through the aforesaid two groups of ball-type moving members, but also acts as limiting a displacement of the lens component and firmly fixing the lens component in the camera module in the focusing process of the camera module; in another aspect, the shell body and the lens component of the camera module are firmly fixed by fastening pieces. Therefore, by the camera module having the aforesaid structural design, an occurrence of a shaking of the lens component in a moving process can be avoided, a blur or a smear in a photographed picture can be avoided, a stability of focusing can be improved, and thus an imaging quality of the camera module can be remarkably improved.

As stated above, the camera module of the present invention has prominent advantages including simple inner structure, easy to be carried, fast response speed of focusing and stable focusing performance.

### BRIEF DESCRIPTION OF THE DRAWINGS

Below, the camera module of the present invention will be explained in detail with reference to accompanying drawings and specific embodiments, wherein:

FIG. 1 illustrates an exploded view of a camera module provided by a first preferred embodiment of the present invention;

FIG. 2 illustrates an enlarged schematic view of a lens component of the camera module shown in FIG. 1;

FIG. 3 illustrates an assembly schematic view of the lens component, a carrier, and a bottom base shown in FIG. 1;

FIG. 4 illustrates a structural schematic view of a coil and a magnet piece included in the camera module shown in FIG. 1.

### DETAILED DESCRIPTION

In order to make the purpose, technical solutions and advantages of the present invention be clearer, the present invention will be further described in detail with reference to accompanying drawings and specific embodiments. It should be understood that the specific embodiments described in the specification are intended to explain but not limiting the present invention.

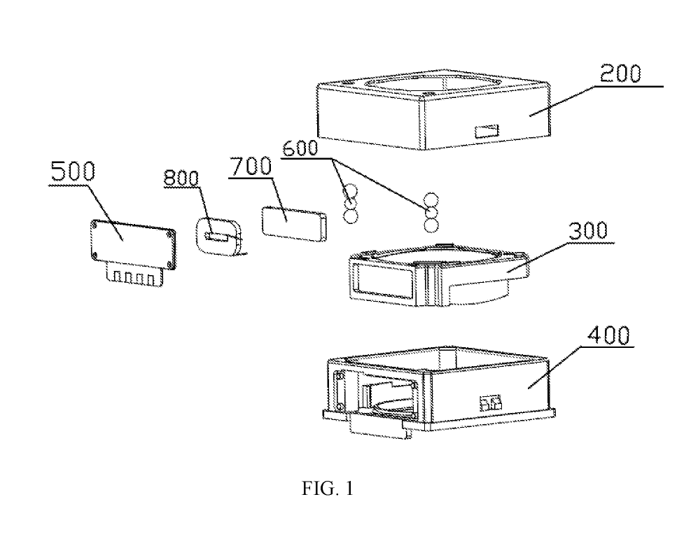

Below, a specific structure and a focusing principle of a camera module of the present invention will be explained in detail with reference to FIGS. 1-4.

As shown in FIG. 1, the camera module of the present invention comprises a bottom base 400, a shell body 200 that is hollow and has an opening on top surface thereof and matched with the bottom base 400, and a lens component 100 and a carrier 300 received in the shell body 200, wherein the lens component 100 is a stretchable lens component 100.

Preferably, the bottom base 400, the shell body 200, the lens component 100 and the carrier 300 are coaxially arranged, and all of them are made of metal material. The shell body 200 is rectangular, and the opening of the top surface of the shell body 200 is circular-shaped, the bottom base 400 is rectangular and is matched with the shell body 200.

Further, the camera module further comprises:

at least two groups of moving members 600 arranged between an outer wall of the carrier 300 and the shell body 200, the lens component 100 is received in the carrier 300 and can move with respect to the bottom base 400 through the at least two groups of moving members 600.

Preferably, each group of moving members 600 comprises at least three balls which are coaxially arranged and aligned from top to bottom, thereby forming a straight line. Wherein as for the at least three balls, the ball located at the top has the same ball diameter with that of the ball located at the bottom, and a ball diameter of the ball located in the middle is slightly smaller than a ball diameter of either of the balls located at the top and the bottom.

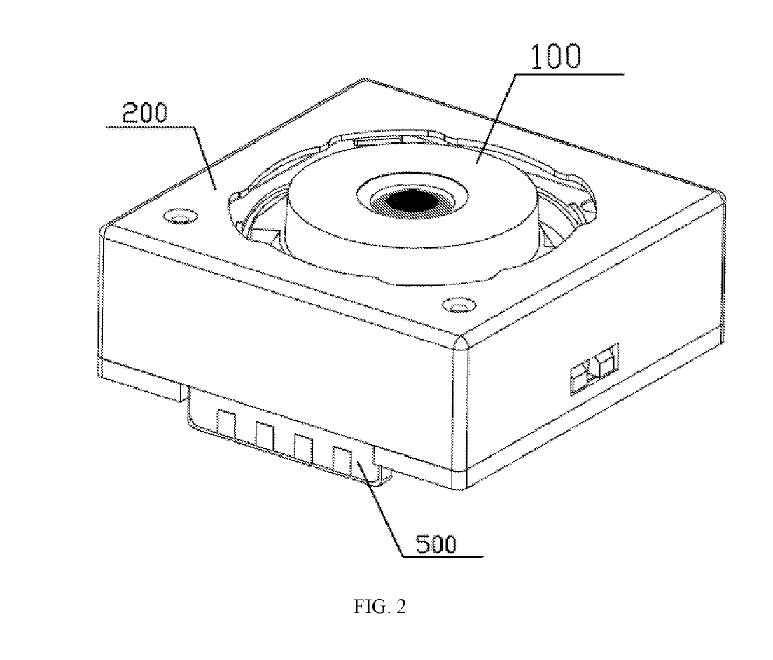

As shown in FIG. 2, the lens component 100 specifically includes a lens mount and a lens embedded in the lens mount. Wherein, the lens has a diameter that is slightly smaller than a diameter of the opening of the top surface of the shell body 200.

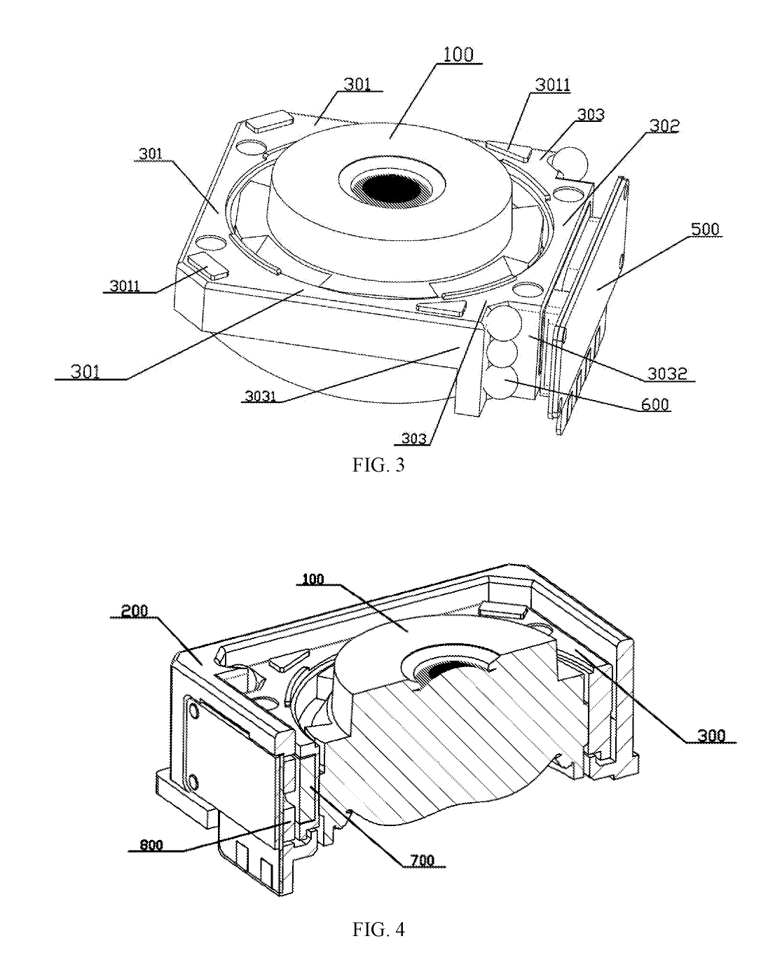

FIG. 3 further shows an assembly schematic view of the lens component 100, the carrier 300 and the bottom base 400. As shown in FIG. 3, the camera module forms a first accommodation area and a second accommodation area between the carrier 300 and the bottom base 400, the first accommodation area and the second accommodation area are configured for accommodating the at least two groups of moving members respectively. The first accommodation area and the second accommodation area are designed with the same shape and size, and this structure design is beneficial for improving structural stability between the carrier 300 and the bottom base 400.

Preferably, the at least three balls are stacked up in a direction vertical to a bottom surface of the bottom base 400, and a stack height of the at least three balls is lower than a height of the first accommodation area or the second accommodation area relative to the bottom surface of the bottom base 400.

Further, an inner wall of the bottom base 400 comprises a carrier matching surface (not shown in the figures) and a lens component displacement reference surface (not shown in the figures).

Correspondingly, the carrier 300 comprises a first lens component limiting member 301 forming by extending along the carrier matching surface, a second lens component limiting member 302 oppositely arranged with respect to the lens component displacement reference surface, and two connecting pieces 303 formed between the first lens component limiting member 301 and the second lens component limiting member 302. It is preferred that, the two connecting pieces 303 are respectively located at two sides of the second lens component limiting member 302 and have identical shape and structure.

Preferably, the carrier matching surface is a substantially circular-shaped surface, and the first lens component limiting member 301 is a circular-shaped metal piece that matches with the circular-shaped surface. The lens component displacement reference surface is substantially rectangle-shaped, and the second lens component limiting member 302 is molded to be rectangle-shaped that matches with the lens component displacement reference surface. The lens component displacement reference surface working as a contact surface of the two groups of moving pieces 600 including the at least two groups of balls is designed to be the rectangle-shaped surface, the advantageous of the design lies in: areas of the contact surface between the carrier 300 and the bottom surface 400 are increased, and the stability of a relative movement between the carrier 300 and the bottom base 400 is improved.

Furthermore, both of the two connecting pieces 303 are recessed in the center axial direction of the carrier 300, and form the first accommodation area and the second accommodation area together with the inner wall of the bottom base 400 at two sides of the second lens component limiting member 302.

Specifically, each of the connecting pieces 303 comprises a first ball limiting part 3031 and a second ball limiting part 3032, the first ball limiting part 3031 is protruded towards the carrier matching surface, the second ball limiting part 3032 connects with one side face of the second lens component limiting member 302, and there is a smooth transition between the second ball limiting part and the side face. The first ball limiting part 3031, the second ball limiting part 3032, the carrier matching surface and the lens component displacement reference surface of the bottom base 400 form the first accommodation area and the second accommodation area together. The at least two groups of moving members 600 are skillfully received in the first accommodation area and the second accommodation area, and work as a “pulley” between the carrier 300 and the bottom base 400. When the camera module performs a focusing operation in response to an instruction from a user, the carrier 300 suffers an electromagnetic force that is parallel to the lens component displacement reference surface and is driven to move along the lens component displacement reference surface with respect to the bottom base 400.

The carrier 300 having the aforesaid design structure forms an approximate inverse U-shaped profile at one side near the first lens component limiting member 301, and forms an approximate Ω-shape profile at another side near the second lens component limiting member 302. In the inner structure of the camera module of the present invention, the carrier 300 can limit a displacement of the camera component 100 through the first lens component limiting member 301 and the second lens component limiting member 302, and achieve a relative movement between the carrier 300 itself and the bottom base 400 through the at least two groups of balls arranged in the first accommodation area and the second accommodation area.

Preferably, the carrier 300 is made of an integrally molded metal piece, such that a structural strength of the carrier 300 is enhanced.

When the camera module is in an unfocused state, the lens component 100 is firmly fixed within the camera module; when the camera module is in a focused state, the carrier 300 is driven by an external force to move along the lens component displacement reference surface with respect to the bottom base 400 under the action of the balls acted as “pulley”, which further drives the lens of the lens component 100 to stretch out or retract from the opening of the shell body 200, thereby achieving an auto-focusing of the camera module.

Furthermore, as shown in FIG. 4, an outer side of the second lens component limiting member 302 is provided with a first mounting hole, and the lens component displacement reference surface on the bottom base 400 arranged oppositely with respect to the second lens component limiting member 302 is correspondingly provided with a second mounting hole.

The camera module further comprises a magnet piece 700 embedded in the first mounting hole, a driver IC (Integrated Chip) 500 embedded in the second mounting hole, and a coil 800 arranged between the driver IC 500 and the magnet piece 700 and electrically connected with the driver IC 500.

Please refer to FIG. 2 and FIG. 3, furthermore, peripheries of the top surface of the shell body 200 is provided thereon with at least three mounting holes, peripheries of a top surface of the first lens component limiting member 301 is correspondingly provided thereon with fourth mounting holes which have the same number with that of the third mounting holes and match with the third mounting holes, the shell body 200 and the carrier 300 are fixed by at least three fastening pieces that respectively pass through at least three pairs of the third mounting holes and the fourth mounting holes. It is preferred that, each of the third mounting holes and the fourth mounting holes is provided with an internal thread, the at least three fastening pieces are respectively provided with an external thread, and the shell body 200 and the carrier 300 are firmly fixed together by a threaded connection, and the aforesaid threaded connection enables a strengthened structural stability of the camera module of the present invention.

Bellow, a focusing process of the camera module of the present invention is described in detail as follows:

When the camera module of the present invention detects a focusing operation of a user, the driver IC 500 receives a focusing instruction from the user, and outputs drive current of different directions to the coil 800 according to the focusing instruction from the user. When the coil 800 is energized, the energized coil 800 generates a magnet field, and imposes a driving force on the carrier 300 by working together with the magnet piece 700; when the carrier 300 is driven by an external force, it moves along the lens component displacement reference surface with respect to the bottom base 400 by the help of the at least two groups of balls received in the first accommodation area and the second accommodation area and acted as the “pulley”, and further drives the lens of the lens component 100 to stretch out or retract from the opening of the shell body 200.

The camera module of the present invention which has the aforesaid structural design has prominent advantages as follows:

One, the camera module has a simple inner structure, the first accommodation area and the second accommodation area are provided between the carrier 300 and the bottom base 400 and configured for respectively accommodating the at least two groups of ball-type moving members, the second lens component limiting member 302 of the carrier 300 and the lens component displacement reference surface of the bottom base 400 are respectively provided with the first mounting hole configured for receiving the coil 800 and the second mounting hole configured for receiving magnet piece 700, thereby making a limited inner space of the camera module be effectively utilized, and implementing a fast focusing functionality.

Two, the carrier 300 comprises the first lens component limiting member 301 that is substantially circular-shaped, the second lens component limiting member 302 that is substantially rectangle-shaped, and two connecting pieces 303 connected between the first lens component limiting member 301 and the second lens component limiting member 302; the carrier 300 forms the approximate inverse U-shaped profile at one side near the first lens component limiting member 3012, and forms the approximate pulse-shaped profile at another side near the second lens component limiting member 302, and the carrier 300 is integrally molded by metal material. The carrier 300 having the aforesaid structural design can not only achieve a relative movement between the lens component 100 and the bottom surface 400 by the aforesaid two groups of ball-type moving members, but also functions as limiting a displacement of the lens component 100 and firmly fixing the lens component 100 in the camera module in the focusing process of the camera module, so that an occurrence of a shaking of the lens component 100 in a moving process can be avoided, a blur or a smear in a photographed picture can be avoided, a stability of focusing can be improved, and thus an imaging quality of the camera module can be remarkably improved.

As stated above, the camera module of the present invention has the prominent advantages including simple inner structure, easy to be carried, fast response speed of focusing and stable focusing performance.

The embodiments of the present invention are described as above with reference to the accompanying drawings; however, the present invention should not be limited to the aforesaid embodiments, the aforesaid specific embodiments are used to be schematic merely but not to be restricted, many modalities can also be made by the one of ordinary skill in the art under the enlightenment of the present invention and without breaking away from the tenets of the present invention and the protection scope of the claims, these modalities should all be included in the protection scope of the present invention. In addition, although some specified technical phrases are used in the specification, these technical phrases are only intended to explain conveniently but not considered as being any limitation to the present invention.

1. A camera module comprising a bottom base (400), a hollow shell body (200) provided with an opening at a top surface thereof and matched with the bottom base (400), a lens component (100) and a carrier (300) received in the shell body (200); the camera module further comprises:
at least two groups of moving members (600) arranged between an outer wall of the carrier (300) and the shell body (200), the lens component (100) is received in the carrier (300) and can move relative to the bottom base (400) through the at least two groups of moving members (600).

2. The camera module according to claim 1, wherein:
each group of moving members (600) comprises at least three balls, the camera module forms a first accommodation area and a second accommodation area between the carrier (300) and the bottom base (400), the at least three balls are stacked up in a direction vertical to a bottom surface of the bottom base (400), and a stack height of the at least three balls is lower than a height of the first accommodation area or the second accommodation area relative to the bottom surface of the bottom base (400).

3. The camera module according to claim 1, wherein:
An inner wall of the bottom base (400) comprises a carrier matching surface and a lens component displacement reference surface;
the carrier (300) correspondingly comprises a first lens component limiting member (301) forming by extending along the carrier matching surface, a second lens component limiting member (302) oppositely arranged with respect to the lens component displacement reference surface, and two connecting pieces (303) formed between the first lens component limiting member (301) and the second lens component limiting member (302) respectively.

4. The camera module according to claim 3, wherein:
each of the connecting pieces (303) is recessed in the center axial direction of the carrier (300) and forms the first accommodation area and the second accommodation area together with one side wall of the bottom base (400) at two sides of the second lens component limiting member (302).

5. The camera module according to claim 4, wherein:
each of the connecting pieces (303) comprises a first ball limiting part (3031) and a second ball limiting part (3032), the first ball limiting part (3031) is protruded towards a direction of the carrier matching surface of the bottom base (400), the second ball limiting part (3032) is connected with one side face of the second lens component limiting member, and there is a smooth transition between the second ball limiting part (3032) and the side face;
the first accommodation area and the second accommodation area are formed by the first ball limiting part (3031) together with the second ball limiting part (3032), the carrier matching surface and the lens component displacement reference surface.

6. The camera module according to claim 3, wherein:
the carrier forms one profile having an approximate inverse U-shape at one side near the first lens component limiting member (301), and forms another profile having an approximate Ω-shape at another side near the second lens component limiting member (302).

7. The camera module according to claim 4, wherein:
the carrier is an integrally formed metal piece.

8. The camera module according to claim 3, wherein:
an outer surface of the first lens component limiting member (301) is provided thereon with various cushions (3011) of different shapes configured for performing isolation protections for the lens component (100).

9. The camera module according to claim 3, wherein:
an outer side of the second lens component limiting member (302) is provided with a first mounting hole, and the lens component displacement reference surface of the bottom base (400) is correspondingly provided with a second mounting hole;
the camera module further comprises:
a magnet piece (700) embedded in the first mounting hole and a driver IC (500) embedded in the second mounting hole; and
a coil (800) arranged between the driver IC (500) and the magnet piece (700) and electrically connected with the driver IC (500); wherein when the coil (800) is energized, it drives the lens component (100) and makes the lens component (100) to move along the lens component displacement reference surface and with respect to the bottom base (400), and further drives a lens in the lens component (100) to stretch out or retract from the opening of the shell body (200).

10. The camera module according to claim 3, wherein:
peripheries of the top of the shell body (200) is provided thereon with at least three third mounting holes, peripheries of a top of the first lens component limiting member (301) is correspondingly provided thereon with fourth mounting holes which have the same number with the third mounting holes and are matched with the third mounting holes, and the shell body (200) and the carrier (300) are fixed together by at least three fastening pieces that respectively pass through at least three pairs of the third mounting holes and the fourth mounting holes that match with each other.
